(19) United States
(12) Patent Application Publication
(10) Pub. No.: US 2002/0003118 A1
(43) Pub. Date: Jan. 10, 2002

(54) Separation device

(75) Inventors: Adrianus Plomp, Schoorl (NL); Maurice Igmar Leander Beumer, Hallum (NL)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: DUST INNOVATION B.V., Schoorl (NL)

(21) Appl. No.: 09/842,864

(22) Filed: Apr. 27, 2001

Related U.S. Application Data
(63) Continuation of application No. PCT/NL99/00666, filed on Oct. 28, 1999.

(30) Foreign Application Priority Data
Oct. 29, 1998 (NL) 1010423

(51) Int. Cl. B01D 21/00

(52) U.S. Cl. 210/802

(57) ABSTRACT

Separation device for separating a fluid from a fluid/particle mixture, comprising a feed and a discharge, which are divided by a displaceable separating wall, which comprises an inflow surface and an outflow surface and is provided with passages, which connect the feed to the discharge, the passages, in the vicinity of the inflow surface, including an acute angle α with the inflow surface (25). The device comprises drive means for displacing the separating wall along a curved path in a direction, as seen from angle α, of that limb of said angle α which lies against the inflow surface. The feed is designed to cause the particle mixture to flow in at an angle γ with respect to the inflow surface which is at most 90°, and that limb of angle γ which lies against the inflow surface extends in the intended direction of displacement of the separating wall.

### CROSS-REFERENCE TO RELATED APPLICATIONS

This is a continuation of PCT/NL/99/0066 filed Oct. 28, 1999.

### FIELD OF THE INVENTION

The present invention relates to a separation device for separating a fluid from a fluid/particle mixture, in which the density of the fluid is lower than that of the fluid/particle mixture, at least comprising a feed for the fluid/particle mixture and a discharge for the fluid which is to be separated, which are divided by a displaceable separating wall, which separating wall comprises an inflow surface on the side of the feed and an outflow surface on the side of the discharge and is furthermore provided with passages which connect the feed to the discharge, the passages, in the vicinity of the inflow surface, including an acute angle α with the inflow surface, and the smallest cross-sectional dimension of the passages being larger than the largest cross-sectional dimension of the particles in the fluid/particle mixture, while the separating wall can be displaced along an at least partially curved path, in a direction of displacement, as seen from angle α, of that limb of the said angle α which lies against the inflow surface, and the feed is designed to cause the particle mixture, in operation, to flow in at an angle γ with respect to the inflow surface.

### BACKGROUND OF THE INVENTION

A device of this nature is known from FR-A-421,251. This document discloses a centrifuge separator for separating air, oil, water etc. from particles. The separator comprises a rotatable drum with lamellae in its outer wall, the interior of the drum being in communication with a discharge, and the drum being located in a chamber into which a fluid mixture which is to be cleaned can be introduced. A vacuum is applied on the discharge side. Separation is effected by the fact that the particles in the fluid/particle mixture enter the passages due to the suction force, where they are entrained into the trajectory of the moving wall. Consequently, the particles are accelerated within the wall, with the result that the particles are driven back outwards from the separating wall, while the air is sucked inwards. In accordance with FR-A-421,251, the fluid/particle mixture is supplied to the separating wall via a feedpipe which, however, is positioned at an obtuse angle γ in the vicinity of the separating wall. The inflow direction of the fluid/particle mixture and the direction of displacement of the wall are in this case substantially identical.

The drawback is that according to FR-A-421,251, the particles have to be collected in the separating wall in order to be subjected to a centrifugal force at the separating wall which is such that the particles are ultimately sufficiently accelerated and are driven out of the passage, entailing multiple collisions between the particles and the separating wall, with the result that the latter is liable to wear and there is a high risk of blockages. Furthermore, there is a high risk that at least some of the particles will pass completely through the separating wall, and consequently separation is not optimum.

Therefore, there is a need for a generally improved separation device for separating fluid from a fluid/particle mixture which does not exhibit the drawbacks mentioned above, which operates reliably, which is able to effectively separate fine solids from a fine solids/gas mixture and which has a long service life.

### SUMMARY OF THE INVENTION

The object of the invention is to eliminate the abovementioned drawbacks, and to this end is characterized in that the feed is designed to cause the particle mixture to flow in at an angle γ with respect to the inflow surface, wherein the angle γ between the inflow direction of the fluid/particle mixture and the inflow surface is at most 90°, and that limb of angle γ which lies against the inflow surface, as seen from angle γ, extends in the intended direction of displacement of the separating wall.

An at least partially curved path is intended to mean that the path comprises an active section in which the movement of the wall describes a curved trajectory, the concave side of the curve defining the discharge side of the separating wall. Preferably, the entire path is curved. The path may also be arcuate or partially arcuate or circular.

In contrast to the device according to the prior art mentioned above, according to the invention the feed is designed precisely in such a manner that γ is 90° or less i.e. in such a manner that the inflow direction has a directional component which is perpendicular or opposite to the direction of displacement of the separating wall.

The mixture can thus be fed radially but, for example, also axially along the separating wall; in the latter case, the mixture flows towards the separating wall at right angles to the inflow surface. The particles will be substantially prevented from entering the passages, as will be described in more detail below. The feed may also comprise, for example, a feed pipe which is positioned tangentially with respect to the axis of rotation of the wall, provided that the angle γ is as defined above.

A very significant advantage of the separation device according to the invention is that it allows the fluid to pass through the passages and prevents the particles from the fluid/particle mixture from entering or passing through the passages, with the result that the particles are retained on the side of the inflow surface, thus ensuring good separation of the fluid from the particles located therein.

Displacing the separating wall in the direction of displacement ensures that the particles which are located in the fluid/particle mixture in the vicinity of the separating wall and are moving towards the wall are made to flow in such a manner with respect to the separating wall that they substantially no longer come into contact with the separating wall, or else are directly returned to the space which contains the fluid/particle mixture as a result of contact or collision with the separating wall, without being entrained with the separated fluid. The particles will therefore substantially fail to enter the passages, thus avoiding the risk of blockage. Without wishing to be tied to any theoretical explanations, it is thought that turbulence is formed in the fluid/particle mixture in the vicinity of the wall, in the area of the openings, within which turbulence particles are deflected away from the main flow of fluid and substantially fail to reach the passages, while the fluid is separated through the passages towards the discharge. The particles reach an area in which the direction of flow of the fluid at that location has a component which is directed away from the inflow side of the separating wall.

The velocity at which the separating wall is advanced with respect to the fluid/particle mixture must be sufficiently high to obtain such a relative inflow direction of the particles with respect to the passages that, if a particle should happen to reach a passage, it will come into contact with the side wall of the passage and rebound into the chamber containing the fluid/particle mixture. It is important for the angle α, which is defined by the passage in question with respect to the inflow surface, to be less than 90°. If a low velocity of the separating wall is selected, the angle α is advantageously selected to have a low value. However, if the velocity of the separating wall is high, a can be selected to have a higher value. If the said velocity is too low or the angle α is too large, it is possible that the particles may not rebound optimally and will continue to escape through the passages towards the outflow surface, with the result that the intended separation will not be guaranteed. All this will be explained in more detail below in the description of the figures. Preferably, the sum of the angles α+γ′ is 90° or less.

It will be clear that, for example, the displacement velocity of the separating wall, the shape and size of the passages, including angle α, can be selected according to the separation process involved, the size and relative density of the particulate material which is to be separated and the desired flow rate of the fluid. Obviously, it remains important that the inflow angle γ should be 90° or less.

nother very important advantage of the separation device according to the invention is that it is moreover not limited to the separation of a fluid from a fluid/particle mixture. The device can also be used to separate a fluid from a fluid/particle mixture in which the particles are solid, liquid or even pasty.

It is important that the particles in the fluid/particle mixture should have a higher density than that of the fluid itself.

The separation device according to the invention rests on a separation principle which is based on the acute inflow angle γ, while the shape of the passages and the relative movement of the separating wall with respect to the fluid/particle mixture, as well as the curved movement path of the separating wall also play a role, and the diameter of the passages does not have to be smaller than that of the particles. Consequently, the particles are not trapped, and do not block the device. Therefore, the maximum possible flow of the fluid remains guaranteed.

Preferably, the passages in the vicinity of the outflow surface, include an acute angle β with the outflow surface, that limb of angle β which lies against the outflow surface, as seen from angle β, extending in the intended direction of movement of the separating wall. Therefore, in the vicinity of the outflow surface, the passages are oppositely directed to the direction of displacement of the separating wall.

Forming the passages in this way in the vicinity of the outflow surface promotes the flow of the fluid out of the passage and prevents the separated fluid from being “scooped back” into the passages.

In a preferred embodiment, the passages are substantially in the shape of a C. This measure ensures that there is as little obstacle to the flow of fluid in the passages as possible, thus allowing the fluid to be guided successfully and without obstacle through the passages.

Preferably, the passages are in the shape of an asymmetric C. In practice it has been found that if the curvature of the passages is greatest in the vicinity of the inflow side of the separating wall, it is possible to obtain a very good separating action in the device.

The passages which are curved in the shape of an asymmetric C are advantageously designed as shown below in FIG. 5. Particularly if the separating wall is of substantially straight design in the axial direction, tests have shown that it is possible to obtain optimum separation of fluid from the fluid/particle mixture.

In particular, the smallest cross-section of the passages is 20-50 000 times preferably 50-5000 times, larger than the largest cross-sectional dimension of the particles in the fluid/particle mixture which is to be separated.

In a following embodiment, the separating wall forms part of an endless belt. In this way, it is possible to achieve a continuous separation process using a limited number of passages. The belt moves along a curved trajectory, if appropriate past a number of turning points, with the result that the separating wall is able to maintain a continuous separation process while being of limited dimensions.

In another preferred embodiment, the separating wall forms the circumferential wall of a drum. The drum comprises passages which are preferably all at the same angle with respect to the radial direction. The drum can be driven axially, in such a manner that the tangential direction of the drum substantially corresponds to the direction of displacement of the separating wall. In this context, it should be noted that the present invention is not limited to a cylindrical drum with straight side walls; drums of other designs, such as polygonal drums or those with a convex wall, are also conceivable. This embodiment provides a separation device which substantially takes up only the space of the drum, resulting in a simple and compact separation device.

In a particular embodiment of the separation device, the separating wall comprises lamellae, and the passages are formed by spaces between the lamellae. The advantage of this arrangement is that the inflow surface is subjected to the minimum possible blockage from fixed components, since the lamellea are generally made from a thin material. In addition, the lamellae are simple to produce, for example by using a mould around which the lamellae can be bent. This provides an inexpensive method which allows the final separating wall to be produced economically. In addition, it is possible, if the lamellae can be removed from the separating wall, to exchange the lamellae easily for other lamellae if they should become damaged or should changed conditions in the separation process require this.

The invention also provides a C-shaped lamella which is intended for use in a separating wall of the device according to the invention.

In addition, the invention provides a method for separating a fluid from a fluid/particle mixture using a separation device according to the invention and at least comprising the following steps:

a) feeding a fluid/particle mixture in the direction of the separating wall,

b) displacing the separating wall along a curved trajectory with respect to the fluid/particle mixture flowing in, in such a manner that the relative inflow direction of the fluid/particle mixture with respect to the inflow surface includes an angle γ′ with respect to the inflow surface, the angle which is formed by the sum of α and γ′ being 90° or less,

c) discharging the fluid via the discharge.

The abovementioned angle γ′ is determined by the vector sum of the velocity and direction of the separating wall with respect to the fluid/particle mixture flowing in. If the separating wall is displaced more quickly, angle γ′ becomes correspondingly smaller and vice versa. The inflow angle γ′ is therefore determined by the velocity and direction with which the fluid/particle mixture moves towards the inflow surface (angle γ) and by the velocity (and direction) of the separating wall.

To prevent the particles from becoming trapped in the passages, the sum of a α+γ′ is 90° or less, as will be explained in more detail below.

Preferably, according to the method the separating wall is displaced in such a manner that the sum of the angle α+γ′ is preferably less than 40°, and more preferably is between 3 and 25°.

### BRIEF DESCRIPTION OF THE DRAWINGS

In the following text, the invention will be explained in more detail with reference to the appended drawing, in which:

FIG. 1 shows an enlarged view of part of a separating wall according to the invention;

FIG. 2 shows a flour silo provided with a separation device according to the invention;

FIG. 3 shows an enlarged, perspective view of part of the device shown in FIG. 2;

FIG. 4 shows a diagrammatic cross section through an embodiment of a separation device according to the invention;

FIG. 5 shows a cross section through a lamella according to the invention;

FIG. 6 shows a second embodiment of a separation device according to the invention.

### DESCRIPTION OF THE PREFERRED EMBODIMENT

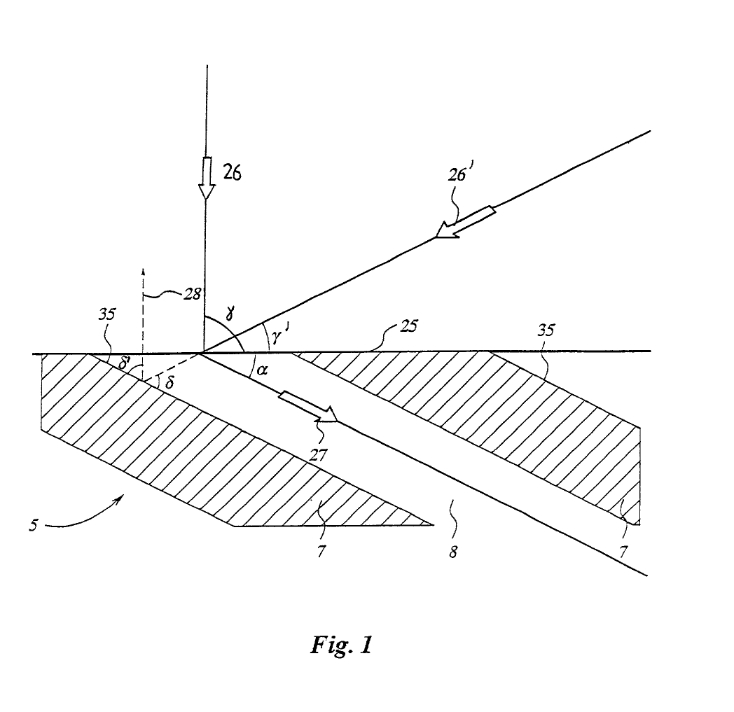

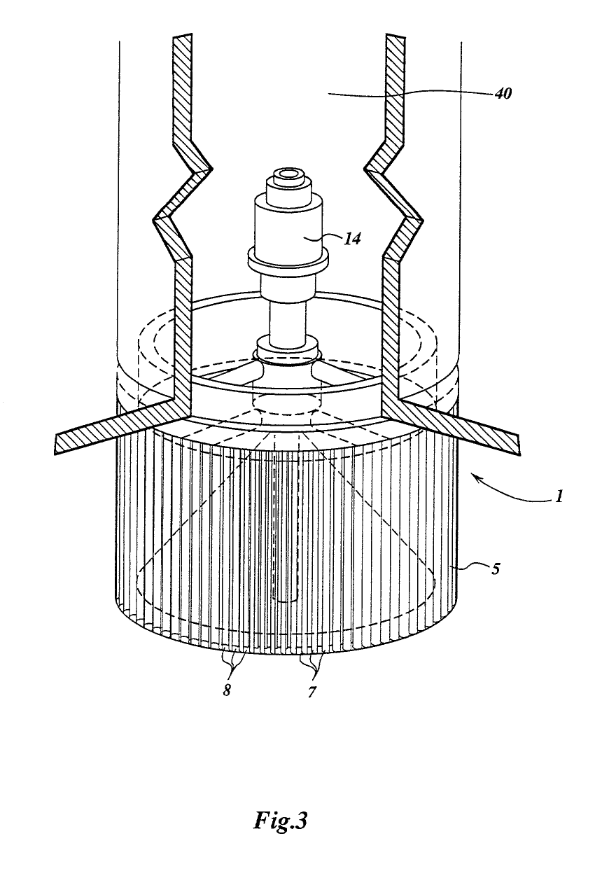

The way in which the separation device according to the invention functions will be explained in more detail with reference to FIG. 1. In FIG. 1, 7 denotes part of a lamella 7. The end of the lamella 7 is located on the inflow surface 25 of a separating wall 5 and, during use, is moved from the left to the right, in the plane of the drawing, i.e. in the direction of that limb of angle α which lies against the inflow surface 25, as seen from angle α. That limb of angle γ which lies against the inflow surface also extends in the direction of displacement of the separating wall. In this diagrammatic illustration, all the ends of the lamellae 7 are shown as being sharp, for the sake of clarity, although they may also be designed differently, for example in rounded form. In the plane of the drawing, the lamellae 7 extend downwards in the shape of a C (not shown). Perpendicular to the plane of the drawing, the lamellae 7 extend substantially in a straight line and end at the limit of the separating wall 5 (see also FIG. 3). The passages 8 are formed by the spaces between the lamellae 7, and the angle α is the angle between the passages 8 and the inflow surface 25.

This figure therefore shows the situation in which the separating wall is moving at a constant velocity. The inflow direction 26, which is illustrated in the figure, flows towards the separating wall 5 at an angle γ of 90°, which according to the invention may also be smaller, with respect to the inflow surface 25. As has already been indicated above, the relative inflow direction, defined by angle γ′, is determined by the vector sum of the velocity of the separating wall 5 and of the velocity and direction of the particles towards the inflow surface 25. If the velocity of the separating wall 5 is slower than the velocity of the separating wall 5 in FIG. 1, the angle γ′ will be larger. In a corresponding manner, in the event of a higher velocity of the separating wall, the angle γ will be smaller than the angle γ′ shown in FIG. 1.

As seen from the moving separating wall, the particles thus move at an angle γ′ in the inflow direction 26′ towards the separating wall 5. The particulate material flowing in will not pass through the passages 8, since they either are forced back by the flow (turbulence) generated in the vicinity of the inflow side 25 of the separating wall 5, and do not come into contact with the lamellae 7, or collide with the lamellae 7 at an angle of a α+γ′, which corresponds to a collision angle δ, and rebound at the same angle δ in the direction of arrow 28 (in this context, completely elastic collision is assumed; if collision is not completely elastic, angle δ will be smaller than δ). Selecting the angle δ to be as small as possible ensures that the angle at which the particles rebound δ′ is, as much as possible oppositely directed to the flow of fluid in the passage. This prevents the particles from still being entrained by the flow of fluid and provides good separation of the particles from the fluid/particle mixture. It can also be seen from the figure that the collision angle δ is equal to the sum of the angles α+γ′. Should circumstances cause the sum of the angles α+γ′ to become larger than 90°, there is a high risk that the colliding particles will be rebounded into the passage 8 and entrained by the fluid, thus reducing the separating action.

In practice, it will be preferable to ensure that the sum of the angles α+γ′, and therefore also δ, is as small as possible. This can be achieved by making the angle of the passages 8 with respect to the inflow surface 25 as small as possible (α as small as possible) or by moving the separating wall 5 as quickly as possible, thus making the relative inflow angle (γ′) as small as possible (in the case of very small angles, this advantage applies to a lesser extent, owing to wall effects). Combinations of the abovementioned measures are, of course, also possible.

If the particles are moving at a random velocity and in a random direction towards the separating wall 5, the value of the relative inflow angle γ′ will not be unamibuously clear. In this case, the velocity of the separating wall is selected to be sufficiently high to ensure that the sum of the maximum value of γ′ and α is 90° or less.

By selecting the maximum relative inflow angle γ′ to be as small as possible, it is possible to select the angle α of the passage 8 to be larger if desired, in order to make the surface area of the passage as large as possible and thus to promote the flow of fluid in the direction of the discharge.

The angle α is advantageously selected in such a manner that the angle included between the relative inflow direction and the passage (the sum of the angles α+γ′) is less than 90°. If the particles collide with the side wall 35 of the passages 8 at an angle δ, they rebound at an angle δ′ of at most the same magnitude and do not enter the passage 8. Advantageously, the sum of the angles α+γ′ is selected to be as small as possible. This makes the collision angle δ as small as possible, with the result that a large, relative, outwardly directed velocity component 28 remains for the particle to rebound from the separating wall 5 towards the chamber containing the fluid/particle mixture. The direction of the flow of fluid in the passage 8 is denoted by 27. The fluid is displaced from the inflow side, through the passages 8, to the outflow side of the passages 8 by means of a pressure difference, which may be generated, for example, by a pump, after which the fluid is discharged through suitable discharge means (not shown here).

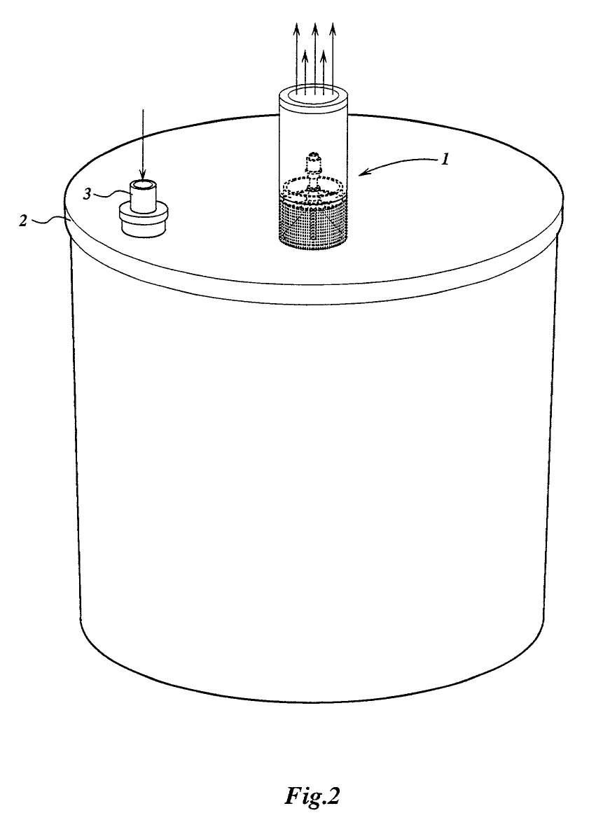

In FIG. 2, 1 generally denotes a separation device according to the invention. This device is located in the wall of a flour silo 2. Furthermore, a flour inlet 3 is diagramatically indicated in the top wall of the flour silo 2. An air/flour mixture can be fed into the silo 2 via the inlet 3. A delivery opening for the flour is not shown in the figure but may, for example, comprise a pipe or funnel at the bottom of the silo.

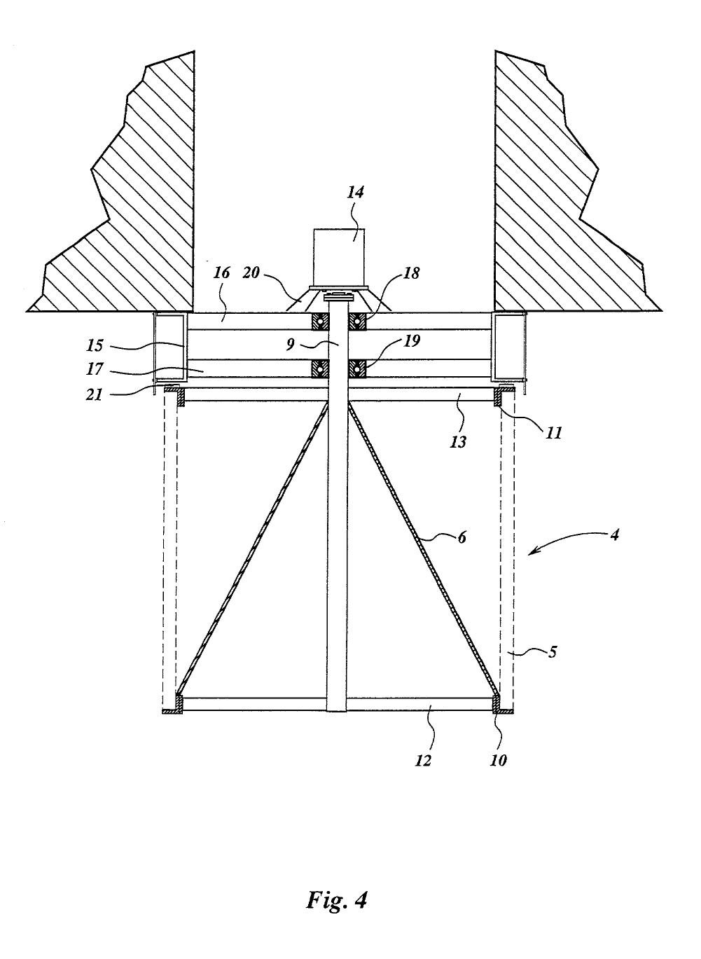

The separation device 1 is shown on a larger scale in FIG. 3, partially broken away, while FIG. 4 shows a diagrammatic cross section through the separation device. This device comprises a drum 4 with a separating wall 5 and a conical bottom end face 6. The drum 4 furthermore comprises a drive shaft 9.

The separating wall 5 is formed by a number of lamellae 7 which are positioned next to one another, with passages 8 between the lamellae 7. The lamellae 7 are held between a bottom ring 10, which is connected to the bottom end face 6, and a top ring 11, which are each coupled to the drive shaft 9 by means of spokes 12 and 13, respectively. The drive shaft 9 can be driven by means of an electric motor 14. However, under certain circumstances the device does not have to include any drive means; sufficient suction from the discharge side alone may be sufficient to cause the separating wall to move in the intended direction. The space in the silo which lies outside the separating wall may be regarded as a feed, while the space inside the separating wall may be regarded as a discharge. Since there are no particular measures for causing the fluid/particle mixture to flow at a specific angle towards the separating wall, the fluid/particle mixture will flow towards the wall at an angle γ of 90°.

In the case illustrated, the bottom end face 6 is of conical design, although this is not necessarily the case. The advantage of this arrangement is that when the device is used any undesirable particulate material which is collected can fall downwards along the conical end face 6 due to the force of gravity and can be thrown out of the drum 4 in the vicinity of the bottom ring 10, via the passages 8 between the lamellae 7.

15 denotes an annular support component which, by means of spokes 16 and 17, carries two bearings 18 and 19, respectively. The drive shaft 9 of the drum 4 is mounted in the bearings 18,19. The drive motor 14 is mounted on the spokes 16 by way of supports 20.

The dual bearing 18,19 ensures that the device 1 operates in a very stable manner while the drum 4 is rotating.

On the top side, in the space between this ring 11 and the annular support component 15, the top ring 11 is provided with small vanes 21 which are positioned at such an angle with respect to the radial direction of the ring 11 that, during rotation of the drum 4, a pressure gradient is generated at the location of the vanes 21, from the drum 4 towards the outside. Consequently, it is possible to ensure that there is a very reliable seal between the drum 4 and the annular component 15, avoiding mechanical contact. Consequently, it is impossible for any particulate material to enter the drum 4 in that area.

The lamellae 7 can be attached to the drum in a variety of ways. This attachment may either be removable or fixed.

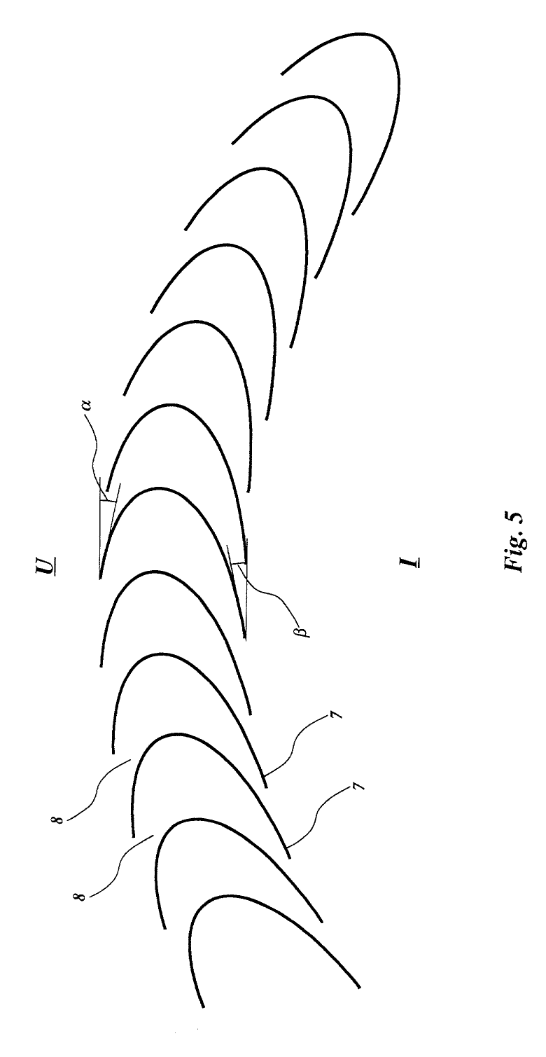

FIG. 5 shows the shape of lamellae which has proven to be optimum when using axially straight lamellae in a device according to the invention, such as that which is shown in FIGS. 3 and 4, for separating, for example, air from an air/flour mixture. The lamellae 7 define a C shaped passage 8.

The length of the lamellae 7, which extend perpendicular to the plane of the drawing, and therefore also determine the height of the passages 8, can be selected as desired, provided that the shape of the passages is maintained. In this context, it is possible to conceive of embodiments in which rings are positioned at a distance from one another, which rings connect the lamellae 7 to one another and thus impart increased rigidity to the lamellae 7, so that the shape of the passages is maintained. Other known embodiments relating to possible ways of increasing the rigidity of the lamellae 7 are also possible, with the passages 8 advantageously not being limited, or being limited only to a very slight extent.

In FIG. 5 the lamellae 7 are slightly asymmetrical. They are more strongly curved in the vicinity of the outer side (U) of the drum 4 than in the vicinity of the inner side (I) of the drum 4. This defines a passage 8 of the shape shown, so that in operation, with a suitable velocity of the separating wall with respect to the fluid/particle mixture flowing in, the particulate material is prevented from being able to move from the outside inwards, and the flow of fluid on the inner side (I) of the drum 4 towards the outlet 40 of the drum 4 is promoted.

As has been stated above, in operation a fluid/particle mixture will flow towards the drum 4. The particulate material flowing in will not pass through the passages, since they either collide with the lamellae 7 and rebound, as has already been explained above, or are returned by the flow generated in the vicinity of the inflow side 25 of the drum 4 and do not come into contact with the lamellae. If particles should unexpectedly get caught in the passages 8 between the lamellae, they will be thrown outwards by the centrifugal force. It is possible that sticky particles, if they come into contact with the lamellae 7, may become deposited on these lamellae in the vicinity of the inflow side of the separating wall 5. As a number of sticky particles continue to accumulate, their size will ultimately be such that they are thrown outwards automatically by the centrifugal force.

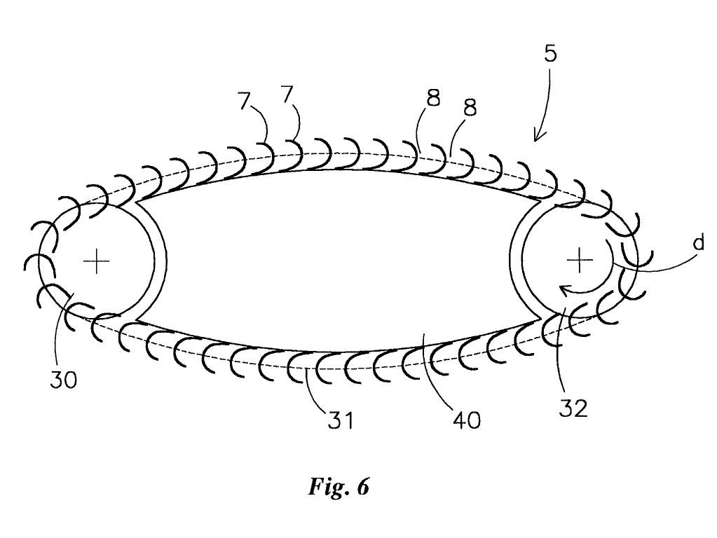

Finally, FIG. 6 shows an embodiment of a separating wall 5 which describes an oval movement path. In this case, lamellae 7 are attached to an endless supporting belt 31 which moves between the turning points 30 and 32. Arrow d denotes the direction of movement of the conveyer belt 31. A supporting belt 31 may, for example, be a chain or other type of linked belt. In the chamber which is enclosed by the supporting belt 31, which holds the lamellae 7, there are discharge means at the location of 40, for the purpose of discharging the fluid (not shown). Furthermore, there are suitable sealing means for sealing the spaces between the ends of the lamellae 7 and the discharge 40 (not shown).

Preferably, however, the separating wall describes a circular movement path, since the centrifugal force in the wall and the turbulence at the location of the inflow surface are then constant and at a maximum level throughout.

In the following text, the invention will be explained in more detail with reference to the following example.

### EXAMPLE

The separation device used according to the invention was composed of a drum with a wall comprising lamellae. The diameter of the drum was 48 cm, the height of the lamellae was 30 cm and the number of lamellae was 60, the cross section of which substantially corresponded to that shown in FIG. 5. On the inside of the drum, there is a reinforcement cone with the drive shaft mounted through its centre, as shown in FIG. 3. The drum is suspended from the top wall of a test chamber, and the interior of the drum is in communication with a discharge duct, as shown in FIG. 3. With the exception of the drive shaft and various attachment components, the device was made from aluminium. The maximum speed of the device was 1500 rpm, with an air flow rate of 2000 m³/h. At the surface of the separating wall, the maximum acceleration in the turbulence was approx. 10,000 g. The chamber is fed from a device which stabilizes the air flow in terms of temperature and atmospheric humidity, and dust from the atmosphere was removed with the aid of an absolute filter. The feed device also comprises a ventilator for displacing air through the dust lock, and a number of drop and dust generators for generating experimental dust and droplet loads in the air. The arrangement is furthermore provided with the necessary measuring equipment for measuring and recording the dust concentration, particle size distribution, air flow rate, temperature and relative atmospheric humidity.

The test measured, inter alia, a blocking efficiency for droplets, in which the efficiency in the case of droplets with a diameter 10 μm was 99%, with a diameter of 5 μm was 98.7°, with a diameter of 3 μm was 98% and with a diameter of 1 μm was 85°.

A test using mist revealed a total blocking efficiency of 99.9950 at 1500 rpm.

Using dust from a sewage purification sludge dryer, in super-saturated air and at a device rotational speed of 1250 rpm, a total blocking efficiency of 99.1° was found.

The device was also used with success in an industrial arrangement for separating air from dry grass dust and fly ash derived from coal firing, with an air flow rate of 20,000 m³/h. The maximum acceleration in the turbulence of the industrial installation was approx. 40,000 g.

Claims is claimed is:

1. Separation device for separating a fluid from a fluid/particle mixture, in which the density of the fluid is lower than that of the fluid/particle mixture, at least comprising
a feed for the fluid/particle mixture and a discharge for the fluid which is to be separated, which are divided by a displaceable separating wall, which separating wall
comprises an inflow surface on the side of the feed and an outflow surface on the side of the discharge and is furthermore provided with passages which connect the feed to the discharge, the passages, in the vicinity of the inflow surface, including an acute angle α with the inflow surface, and the smallest cross-sectional dimension of the passages being larger than the largest cross-sectional dimension of the particles in the fluid/particle mixture, while
the separating wall can be displaced along an at least partially curved path, in a direction of displacement, as seen from angle α, of that limb of the said angle α which lies against the inflow surface, and
the feed is designed to cause the particle mixture, in operation, to flow in at an angle γ with respect to the inflow surface
wherein the angle γ between the inflow direction of the fluid/particle mixture and the inflow surface is at most 90°, and that limb of angle γ which lies against the inflow surface, as seen from angle γ, extends in the intended direction of displacement of the separating wall.

2. Separation device according to claim 1, wherein the passages, in the vicinity of the outflow surface, include an acute angle β with the outflow surface, that limb of angle β which lies against the outflow surface, as seen from angle β, extends in the intended direction of movement of the separating wall.

3. Separation device according to claim 1, wherein the passages are substantially in the shape of a C, preferably an asymmetric C, more preferably an asymmetric C which corresponds to that shown in FIG. 5.

4. Separation device according to claim 1, wherein the smallest cross section of the passages is 20-50 000 times preferably 50-5000 times, larger than the largest cross-sectional dimension of the particles in the fluid/particle mixture which is to be separated.

5. Separation device according to claim 1, wherein the separating wall forms a component of an endless belt.

6. Separation device according to claim 1, wherein the separating wall forms a circumferential wall of a drum.

7. Separation device according to claim 1, wherein the separating wall comprises lamellae, and the passages are formed by spaces between the lamellae.

8. Separation device according to claim 1, wherein it comprises drive means for displacing the separating wall along a curved path.

9. Lamella, obviously intended for use in a separating wall of the device according to claim 1, the cross section of which lamella corresponds to that shown in FIG. 5.

10. Method for separating a fluid from a fluid/particle mixture using a separation device according to claim 1, at least comprising the following steps:
feeding a fluid/particle mixture in the direction of the separating wall,
displacing the separating wall along a curved trajectory with respect to the fluid/particle mixture flowing in, in such a manner that the relative inflow direction of the fluid/particle mixture with respect to the inflow surface includes an angle γ′ with respect to the inflow surface, the angle which is formed by the sum of α and γ′ being 90° or less,
discharging the fluid via the discharge.

11. Method according to claim 10, wherein the separating wall is displaced in such a manner that the sum of the angles α+γ′ is less than 40°, and is preferably between 30 and 25°.
